(19) United States
(12) Patent Application Publication
(10) Pub. No.: US 2026/0048878 A1
(43) Pub. Date: Feb. 19, 2026

(54) Base Stations For Unmanned Aerial Vehicles And Stands For Use Therewith

(71) Applicant: Skydio, Inc., San Mateo, CA (US)

(72) Inventors: George Oliver Turvey, Brookdale, CA (US); Yee Shan Woo, Campbell, CA (US); Shun Yao, Fremont, CA (US)

(21) Appl. No.: 19/222,069

(22) Filed: May 29, 2025

Related U.S. Application Data
(60) Provisional application No. 63/683,520, filed on Aug. 15, 2024.

(51) Int. Cl. B64U 80/70; B64U 10/14; B64U 70/92; B64U 70/97; B64U 70/99; B64U 80/25

(52) U.S. Cl. CPC B64U 80/70; B64U 80/25; B64U 10/14; B64U 70/92; B64U 70/97; B64U 70/99

(57) ABSTRACT

A base station for a UAV includes a base and a roof assembly movably coupled to the base and movable between a closed position, in which the roof assembly is configured to enclose a landing platform, and an open position, in which the landing platform is unobstructed by the roof assembly. The base station further includes a stand that includes a first leg, a second leg, a frame extending between the first leg and the second leg, and a spreader plate supported by at least one of the first leg and the second leg, wherein the spreader plate is configured to support the base. The stand is configured to support one or more of power transmission and data transmission to the base station via the stand.

### CROSS-REFERENCE TO RELATED APPLICATION(S)

This application claims priority to and the benefit of U.S. Provisional Patent Application Ser. No. 63/683,520, filed Aug. 15, 2024, the entire contents of which are incorporated by reference herein for all purposes.

### TECHNICAL FIELD

The present disclosure relates to a base station for an unmanned aerial vehicle (UAV) and, more specifically, to drainage of the base station.

### BACKGROUND

A base station for a UAV is designed to house and protect the UAV when not in use. The base station may often include a landing platform on which the UAV may take flight and land. For example, the base station may include one or more fiducial markings that may be detected by an image sensor (e.g., a camera) of the UAV. Based upon detection of the one or more fiducial markings, the UAV may execute a landing procedure to safely land on the landing platform of the base station. Additionally, the base station may include an integrated charging system so that, when the UAV is not in use and stored on the landing platform, the integrated charging system may replenish a power supply of the UAV (e.g., a battery of the UAV).

### SUMMARY

In one aspect of the present disclosure, a docking system for a UAV is disclosed that includes a base station and a stand that is configured to support the base station.

The base station includes a roof assembly and a base that supports the roof assembly.

The base includes: a body; a landing platform that is supported by the body; a temperature control system that is positioned within the base and which is configured to thermally condition the base station and the UAV; and a charging hub that is configured for electrical connection to the UAV to facilitate charging thereof.

The landing platform includes: slots; landing areas, which are configured to receive the UAV during docking; and alignment members, which are movable within the slots. The alignment members are configured for engagement with the UAV and are repositionable between extended and retracted positions.

The stand includes: a spreader plate that is configured for engagement with the base station; uprights that extend from the spreader plate; a brace that extends from the uprights; and at least one port that is configured to receive a transmission member to support power and/or data transmission to the base station via the stand.

In some configurations, the base station may further include at least one drain channel to allow for water egress.

In some configurations, the at least one drain channel may direct water away from the slots in the landing platform.

In some configurations, the at least one drain channel may direct water away from the temperature control system.

In some configurations, the at least one drain channel may direct water away from the charging hub.

In some configurations, the at least one drain channel may direct water away from a user panel.

In some configurations, the at least one drain channel may direct water away from an intake vent.

In some configurations, the base station may further include at least one drain heater that is configured to de-ice the at least one drain channel.

In some configurations, the charging hub may be repositionable between a retracted position, in which the charging hub is concealed by the landing platform, and an extended position, in which the charging hub is exposed from the landing platform.

In some configurations, the charging hub may extend through the landing platform in the extended position.

In some configurations, the stand may further include at least one alignment pin that extends outwardly from the spreader plate and which is configured for insertion into the base station.

In some configurations, the uprights may extend along a first axis, and the brace may extend along a second axis.

In some configurations, the stand may be configured such that the first axis and the second axis subtend an angle therebetween that lies substantially within the range of approximately 30 degrees to approximately 75 degrees.

In some configurations, the uprights may include at least one storage compartment.

In some configurations, the brace may include a notch that creates a locking point.

In some configurations, the stand may include at least one mounting point to support permanent installation at a docking site.

In another aspect of the present disclosure, a base station for a UAV is disclosed. The base station includes a base that includes a body defining a cavity therein and a landing platform supported by the body and configured to support the UAV. The base station further includes a roof assembly movably coupled to the base and movable between a closed position, in which the roof assembly is configured to enclose the landing platform, and an open position, in which the landing platform is unobstructed by the roof assembly. The base station also includes a stand having a first leg, a second leg, a frame extending between the first leg and the second leg, and a spreader plate supported by at least one of the first leg and the second leg, whereby the spreader plate is configured to support the base. The stand is configured to support one or more of power transmission and data transmission to the base station via the stand.

In some configurations, the spreader plate may define an upper surface of the stand. A lower surface of the base may abut the upper surface of the spreader plate so that the base is supported by the stand.

In some configurations, the first leg may define a first cavity therein that is accessible through one or more openings defined by the first leg. The second leg may define a second cavity therein that is accessible through one or more openings defined by the second leg. The first cavity may permit routing of wiring through the first leg to connect the wiring to the base station. The second cavity may permit routing of additional wiring through the second leg to connect the additional wiring to the base station. The wiring may be configured to transmit power to the base station via the stand and the additional wiring may be configured to transmit data to the base station via the stand.

In some configurations, the spreader plate may include one or more guide pins that are received by the body of the base to align the base with the stand. The base may be secured to the spreader plate when the base is aligned with the stand.

In some configurations, the frame may be spaced apart from the spreader plate in an elevational direction of the base station. The frame and the spreader plate may extend along planes that are substantially parallel to one another.

In some configurations, the roof assembly may be configured for positioning at least partially between the base and the stand when the roof assembly is in the open position.

In another aspect of the present disclosure, a base station for a UAV is disclosed. The base station includes a base that is configured to support the UAV and a stand coupled to the base and configured to support the base. The stand includes a first leg defining a first cavity therein, a second leg defining a second cavity therein, a frame extending between the first leg and the second leg, and a spreader plate coupled to and supported by the first leg and the second leg. The frame defines a frame cavity therein that is accessible via one or more of the first cavity and the second cavity. The spreader plate is coupled to the base to support the base thereon. Moreover, the spreader plate defines one or more apertures that permit access to one or more of the first cavity of the first leg and the second cavity of the second leg.

In some configurations, wiring may be routable through the stand to connect the wiring to the base by routing the wiring into the frame cavity, through the frame cavity, into the first cavity, and through the first cavity such that the wiring exits the first cavity through the one or more apertures of the spreader plate.

In some configurations, wiring may be routable through the stand to connect the wiring to the base by routing the wiring into the frame cavity, through the frame cavity, into the second cavity, and through the second cavity such that the wiring exits the second cavity through the one or more apertures of the spreader plate.

In some configurations, the spreader plate may define a first aperture that permits access to the first cavity of the first leg and a second aperture that permits access to the second cavity of the second leg.

In some configurations, the first cavity may be accessible via one or more openings defined by the first leg, The one or more openings may be enclosed by one or more access panels.

In some configurations, the second cavity may be accessible via one or more additional openings defined by the second leg. The one or more additional openings may be enclosed by one or more additional access panels.

In some configurations, the frame may define a first opening and a second opening that permit access to the frame cavity. The first opening may be aligned with the first leg such that the frame cavity is accessible through the first opening of the frame from within the first cavity of the first leg. The second opening may be aligned with the second leg such that the frame cavity is accessible through the second opening of the frame from within the second cavity of the second leg.

In another aspect of the present disclosure, a stand for a base station for a UAV is disclosed. The stand includes a first leg defining a first cavity therein, a second leg defining a second cavity therein, a spreader plate coupled to the first leg and the second leg, and a frame extending between the first leg and the second leg. The spreader plate is configured to support the base station, and the frame defines a frame cavity therein. Wiring is routable through one or more of the first cavity, the second cavity, and the frame cavity to transmit one or more of power and data to the base station via the stand. The stand includes counterweighting such that the stand is configured to remain stationary when a roof assembly of the base station moves between a closed position and an open position with respect to the base station.

In some configurations, the first leg and the second leg may extend substantially perpendicular to the frame and the spreader plate.

In some configurations, the first leg may extend along a first axis and the frame may extend along a second axis. An angle between the first axis and the second axis may be within a range of about 30 degrees to about 75 degrees.

In some configurations, the spreader plate may define an upper surface of the stand. The spreader plate may include a pair of guide pins that project away from the spreader plate and are receivable by the base station to align the base station with the stand.

In some configurations, the stand may further include one or more adjustable feet configured to adjust a height of the stand with respect to an elevational direction. The one or more adjustable feet may each include a spindle that is located in the frame cavity and is rotatable to adjust the height of the stand.

### BRIEF DESCRIPTION OF THE DRAWINGS

The present disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of a docking system for a UAV.

FIG. 2 is a front view of the docking system.

FIG. 3 is a side view of the docking system.

FIG. 4 is a rear view of the docking system.

FIG. 5 is a perspective view of the base station illustrating a landing platform of the UAV.

FIG. 6 is a top view of the landing platform with the alignment members shown in extended positions.

FIG. 7 is a top view of the landing platform with the alignment members shown in retracted positions.

FIG. 8 is a side view of the base station.

FIG. 9 is a top view of the base station illustrating the temperature control system of the base station.

FIG. 10 is a perspective view illustrating connection of the UAV to a charging hub of the base station.

FIG. 11 is a cross-sectional view of the alignment members of the landing platform.

FIG. 12 is a perspective view of the stand.

FIG. 13 is a perspective view of the stand illustrating a port that receives a transmission member.

FIG. 14 is a perspective view of the stand connected to a docking site.

FIG. 15 is a perspective view of a base station for a UAV.

FIG. 16 is a front view of the base station.

FIG. 17 is a partially exploded view of the base station.

FIG. 18A is a perspective view of a stand of the base station.

FIG. 18B is a close-up perspective view of the stand shown in FIG. 18A.

FIG. 19 is a top view of the stand.

FIG. 20 is a bottom view of the stand.

FIG. 21 is a perspective view of the stand illustrating an interior of the stand.

FIG. 22 is a side view of the stand illustrating routing of wiring through the stand.

FIG. 23 is a close-up view of an adjustable foot of the stand.

FIG. 24 is a side view of the adjustable foot of the stand.

### DETAILED DESCRIPTION

The present disclosure relates to a base station for use with an unmanned aerial vehicle (UAV). The base station may be configured to support the UAV when the UAV is not operating. The base station may be configured to charge a power source (e.g., a battery) of the UAV when the UAV is supported by or contained within the base station. For example, the base station may include a support assembly, such as a landing platform, which may support the UAV during periods of inactivity (e.g., when not in use) and may further support the UAV during takeoff and landing. The landing platform may be positioned within the base station such that, when the UAV is docked (e.g., supported by the landing platform), the base station may contain the UAV.

In an example, the base station may include a base, which may include or be the landing platform, and a roof assembly. The roof assembly may be movable so that, when the UAV is docked, the roof assembly may at least partially enclose the UAV such that the UAV is no longer exposed to environmental conditions, such as precipitation (e.g., rain, snow, hail, etc.), wind, extreme temperatures (e.g., extreme heat and/or cold), sunlight, debris, other external factors, or a combination thereof. Additionally, when the UAV is prepared for takeoff, the roof assembly may be movable so that the landing platform remains unobstructed by the roof assembly and the UAV may safely take off from the landing platform.

Conventional base stations may often be mechanically complex to ensure proper docking of the UAV. Similarly, conventional base stations may frequently require significant operator interaction to ensure proper takeoff and landing of the UAV. For example, the operator may be required to manually move a portion of the base station (e.g., a cover) to ensure that takeoff and landing of the UAV remains unobstructed. Additionally, conventional base stations may often provide a landing surface for the UAV yet provide no protection to the landing surface and/or the UAV once docked. For example, conventional base stations may not include a roof assembly to prevent exposure of one or more of the landing surface, electronics of the base station, or the UAV to various environmental conditions, such as those described above.

The present teachings provide a base station that addresses the aforementioned challenges. The base station herein may advantageously be substantially or entirely automated to substantially alleviate user interaction. The base station herein may also provide protection to the base station and the UAV. For example, the base station may partially or entirely enclose the landing platform to protect the landing platform and the UAV from environmental conditions. Additionally, the base station may include one or more defined drainage paths to ensure that drainage (e.g., water, such as rain, or other fluids, herein referred to as “fluid” or “fluids,” which may be inclusive of any fluid, including water, or a combination of fluids) is directed away from components of the base station. For example, the base station may define one or more drainage paths to direct the drainage away from one or more of electronics or a thermal management system of the base station.

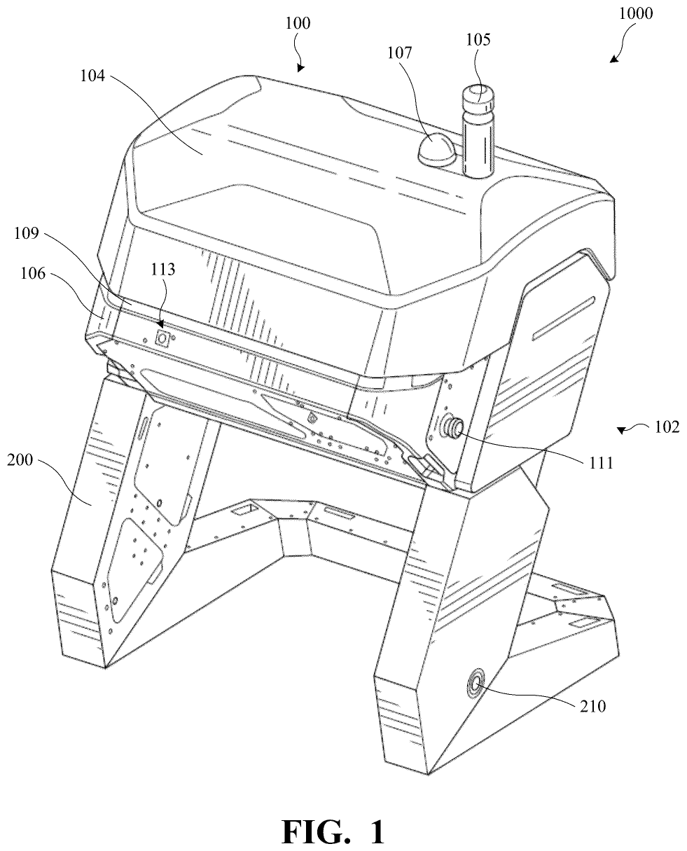

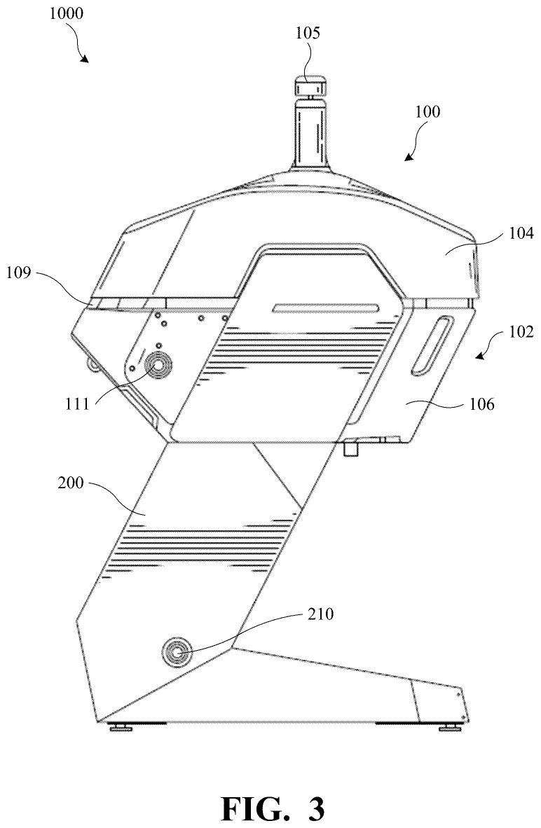

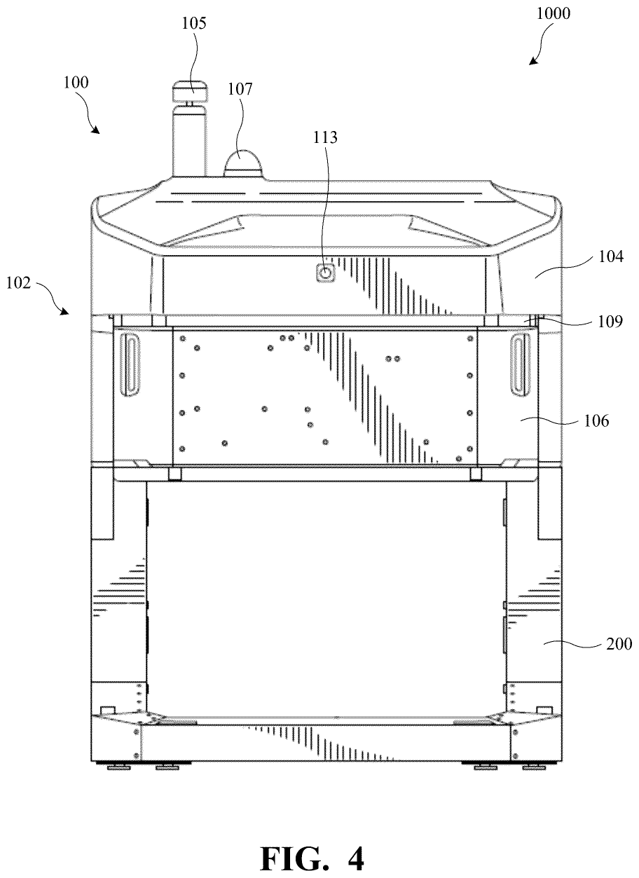

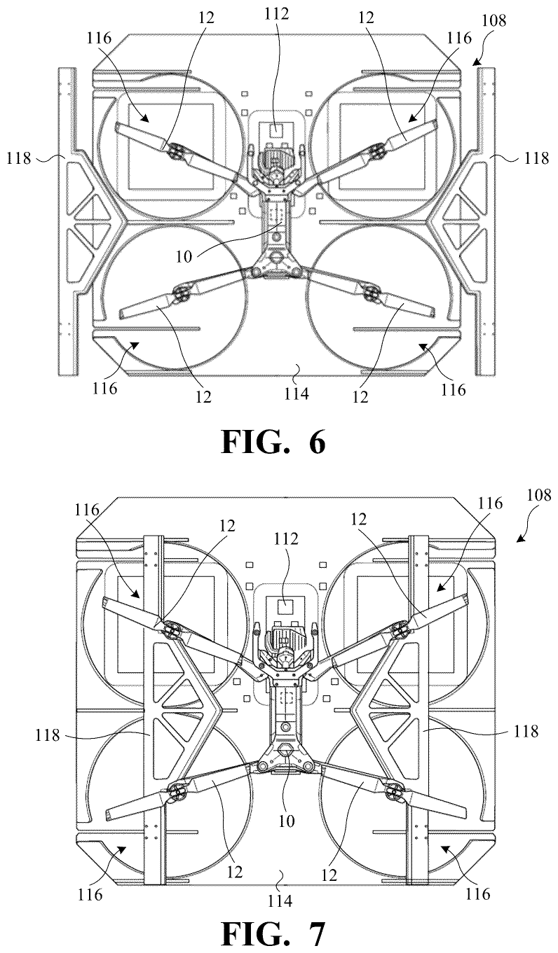

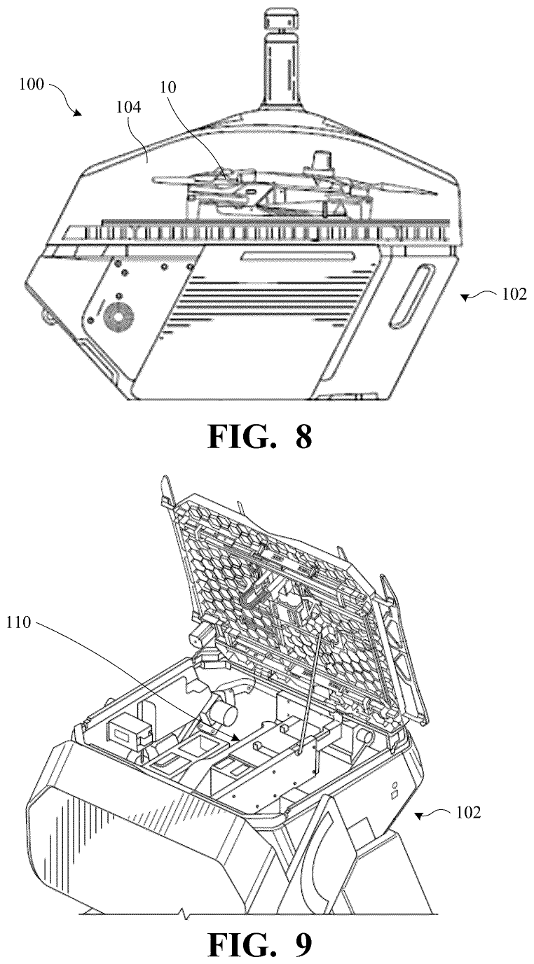

Referring now to the drawings, FIGS. 1-4 illustrate a docking system 1000 that includes a base station 100 (e.g., a dock) for a UAV 10 (shown FIGS. 6-8, 10), which is configured for automated servicing (e.g., storage, charging, operation, etc.) and accommodation of the UAV 10, and a stand 200, which is configured to support the base station 100 in an elevated position. While the docking system 1000 and the UAV 10 are shown and described herein, in certain embodiments of the disclosure, it is envisioned that a plurality of docking systems and UAVs may be utilized depending, for example, upon the particular intended use of the UAVs.

The base station 100 includes a base 102 and a roof assembly 104, which is supported by the base 102 such that the roof assembly 104 is repositionable between a closed position, in which the UAV 10 is concealed within the base station 100, and an open position, which facilitates takeoff and landing of the UAV 10. The roof assembly may include, for example, a wind sensor 105, a rain sensor 107, other sensors, or a combination thereof.

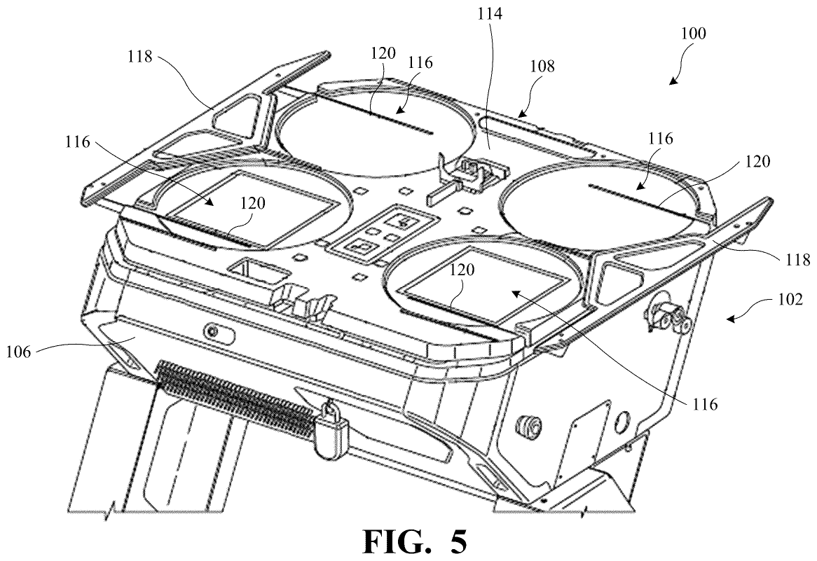

With reference now to FIGS. 5-10 as well, the base 102 includes: a body 106 (e.g., an enclosure), which is the main structural member of the base 102 and supports various internal and external components of the base station 100; a landing platform 108, which is supported by (e.g., connected (secured) to the body 106 and receives the UAV 10 during docking; a temperature control system 110 (e.g., a heating and cooling system, as shown in FIGS. 5 and 9), which is configured to thermally condition (e.g., cool and heat) the base station 100 and the UAV 10 when docked (subject to environmental conditions); a charging hub 112; indicator lighting 109, which may provide a visual indication (e.g., light indication) of operation of the base station 100 and/or the UAV 10; one or more user interfaces (e.g., buttons, switches, capacitive touch sensors, toggles, etc.), such as the user interface 111, which may provide a user control of the base station 100 (e.g., emergency stop button, manual open/close button, etc.); and one or more cameras, such as the camera 113, which may capture images and/or video (e.g., live feed) of an area surrounding the docking system 1000.

The landing platform 108 includes a stage 114 defining landing areas 116 (FIG. 11) and a pair of alignment members 118 (e.g., a first and a second alignment member).

The landing areas 116 receive and constrain the UAV 10 during docking with the base station 100. More specifically, the landing areas 116 receive legs 12 (FIGS. 6, 7) of the UAV 10 and correspond in number thereto.

The alignment members 118 configured for engagement (contact) with the UAV 10 (i.e., the legs 12) and are movable (repositionable) in relation to the stage 114 between extended positions (FIG. 6), in which the alignment members 118 are spaced laterally outward of the landing areas 116 in order to facilitate docking of the UAV 10 with the base station 100, and retracted positions (FIG. 7), in which the alignment members 118 are generally aligned with and are positioned (vertically) above the landing areas 116. More specifically, during repositioning between the extended and retracted positions, the alignment members 118 are movable within slots 120 in the landing platform 108.

The temperature control system 110 (FIGS. 5 and 9) is supported by and positioned (retained, accommodated) within the base 102 and is configured to thermally condition (e.g., cool and heat) the base station 100 and the UAV 10 when docked (subject to environmental conditions). The temperature control system 110 includes: a fan; a filter; a ducting system; (one or more) at least one heat sink in thermal communication with the ducting system; and a thermoelectric conditioner (TEC) in thermal communication with the heat sink(s).

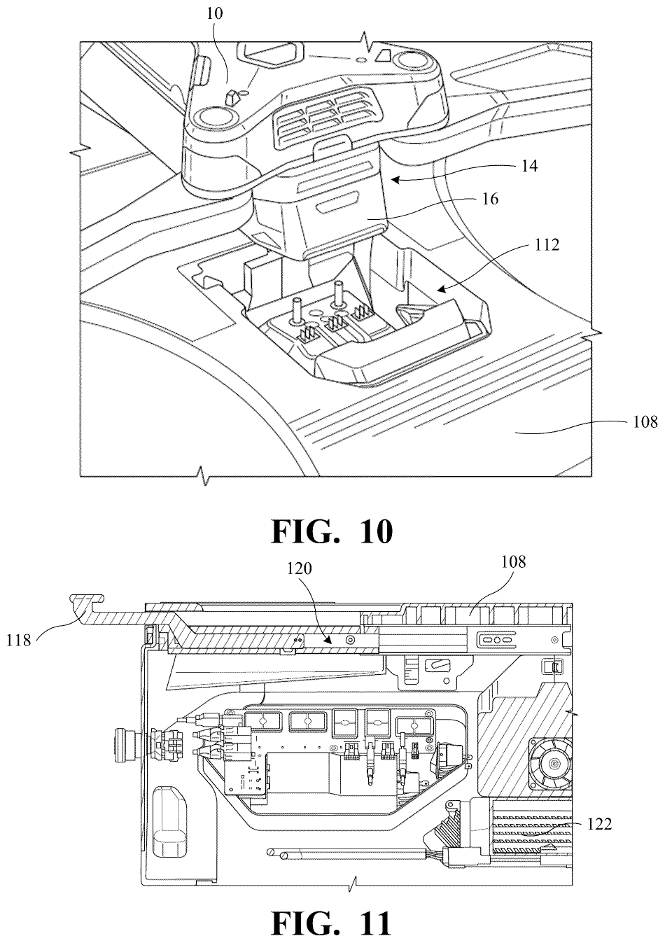

The charging hub 112 (FIGS. 5-7, 10) is configured for engagement (contact) with and electrical connection to a power source 14 (FIG. 10) (i.e., a battery 16) on the UAV 10, which is located (e.g., attached to or otherwise supported on) a lower (bottom) surface thereof, and may draw power from any suitable source, whether internal to the base station 100 or external. The charging hub 112 is repositionable between a retracted position, in which the charging hub 112 is concealed by the landing platform 108, and an extended position, in which the charging hub 112 is exposed from and extends (vertically) through the landing platform 108 to facilitate connection to and charging of the UAV 10.

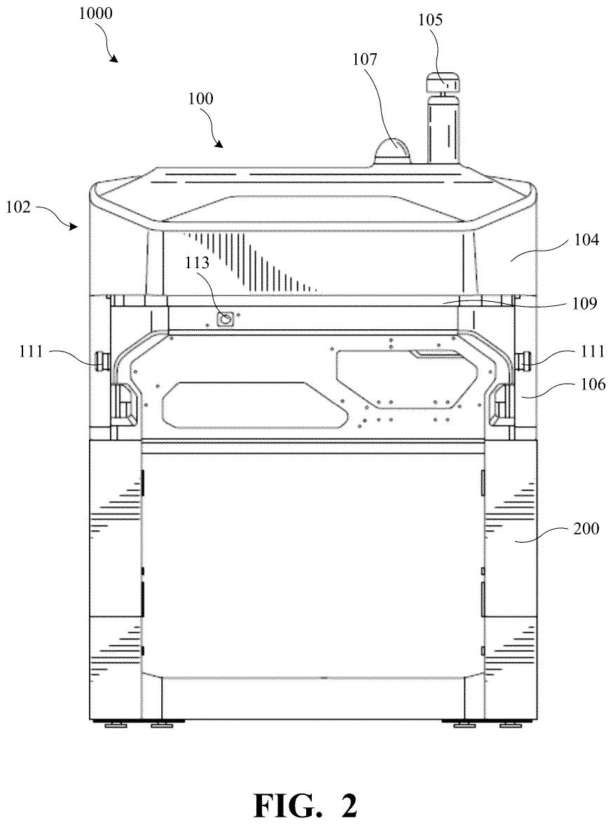

With reference now to FIG. 11 as well, the base station 100 includes (one or more) at least one drain channel (e.g., drain hole(s), path(s), gutter(s), etc.) to allow for fluid (e.g., water) egress during inclement weather and facilitate the evacuation of fluid resulting from condensation, ice melt, etc. For example, the base station 100 may drain fluid away from the landing platform 108 (i.e., the alignment members 118 and the slots 120), which supports repositioning of the alignment members 118 in the presence of fluid and inhibits the formation of ice around the alignment members 118 that may otherwise impede the functionality thereof, may drain fluid (e.g., condensation) away from the temperature control system 110 (e.g., the TEC), and may drain water away from the charging hub 112. It is also envisioned that the base station 100 may include one or more additional drain channels in order to facilitate the drainage of fluid from the user panel (FIGS. 1, 2) and/or the intake vent (FIG. 5).

With reference to FIG. 11, in certain embodiments, it is envisioned that the base station 100 may further include (one or more) at least one drain heater 122 (e.g., resistive heater pads) that are configured to de-ice the drain channel(s) and thereby melt ice that might otherwise obstruct the flow of fluid away from the landing platform 108 (i.e., the alignment members 118 and the slots 120), the temperature control system 110 (FIGS. 5 and 9), the charging hub 112 (FIGS. 5-7 and 10), etc.

With reference now to FIGS. 12-14, the stand 200 will be discussed. The stand 200 is a free-standing structure that is configured to support the base station 100 (and the UAV 10) in an elevated position, as indicated above, which creates free air space that not only reduces turbulence (e.g., propeller wash) during takeoff and landing of the UAV 10, but mitigates the entry of debris (e.g., dust, particulate, etc.) into the base station 100.

The stand 200 includes: a spreader plate 202, which supports and is configured for engagement (contact) with the base station 100; (one or more) at least one alignment pin 204, which extends outwardly (i.e., vertically) from the spreader plate 202 and is configured for insertion into the base station 100 in order to facilitate proper orientation of the base station 100 in relation to the stand 200 and inhibit dislocation of the base station 100 (i.e., separation of the base station 100 and the stand 200) prior to connection; (a pair of) uprights 206, which extend from the spreader plate 202 along a (first) axis X1; and a brace 208, which extends from the uprights 206 along a (second) axis X2.

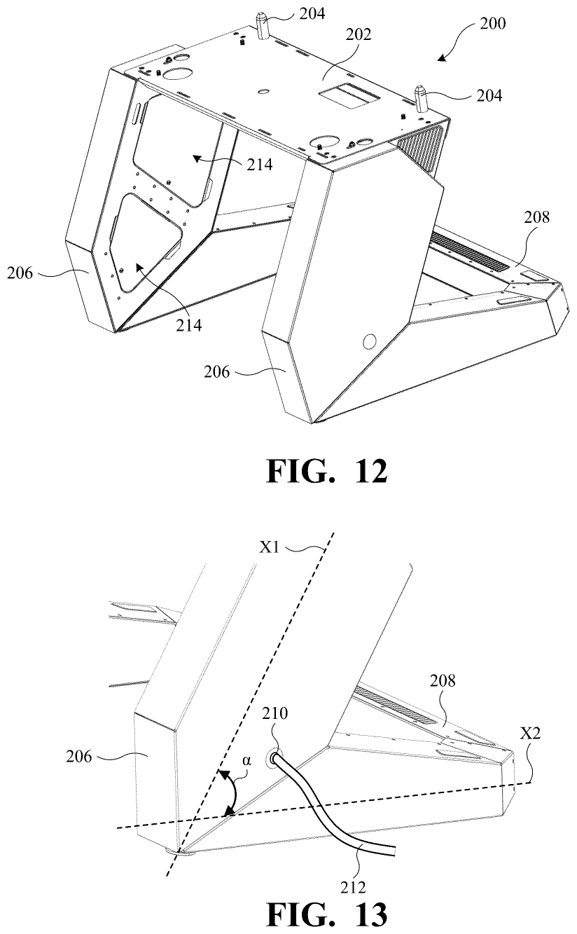

As seen in FIG. 13, in the illustrated embodiment, the stand 200 is configured such that the axes X1, X2 subtend an angle α therebetween that lies substantially within the range of about 30 degrees to about 75 degrees. Embodiments in which the stand 200 may be configured such that the angle α lies outside of the disclosed range are also envisioned herein (e.g., depending upon the size, weights, etc., of the base station 100), however, and would not be beyond the scope of the present disclosure.

As seen in FIGS. 1, 3, and 13, the stand 200 includes (one or more) at least one port (e.g., entry point), such as the port 210, which is configured to receive (one or more) at least one (power and/or data) transmission member 212 (e.g., wire(s), cable(s), FPC(s), etc.) to support power and/or data transmission to the base station 100 via the stand 200. Although shown as being included on one of the uprights 206 in the illustrated embodiment, it is envisioned that the port 210 may be included in any suitable location (e.g., the brace 208).

In certain embodiments, it is envisioned that the uprights 206 may include (one or more) at least one storage compartment 214 (FIG. 12) (e.g., for tools, fasteners, etc.). Additionally, or alternatively, it is envisioned that the brace 208 may include a notch to create a locking point.

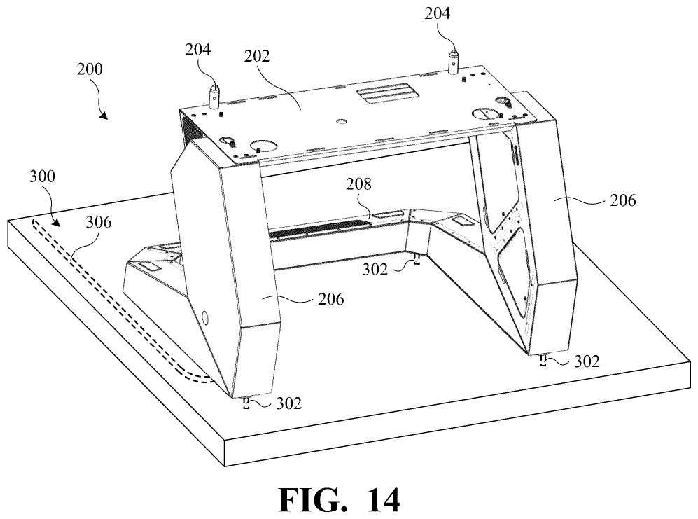

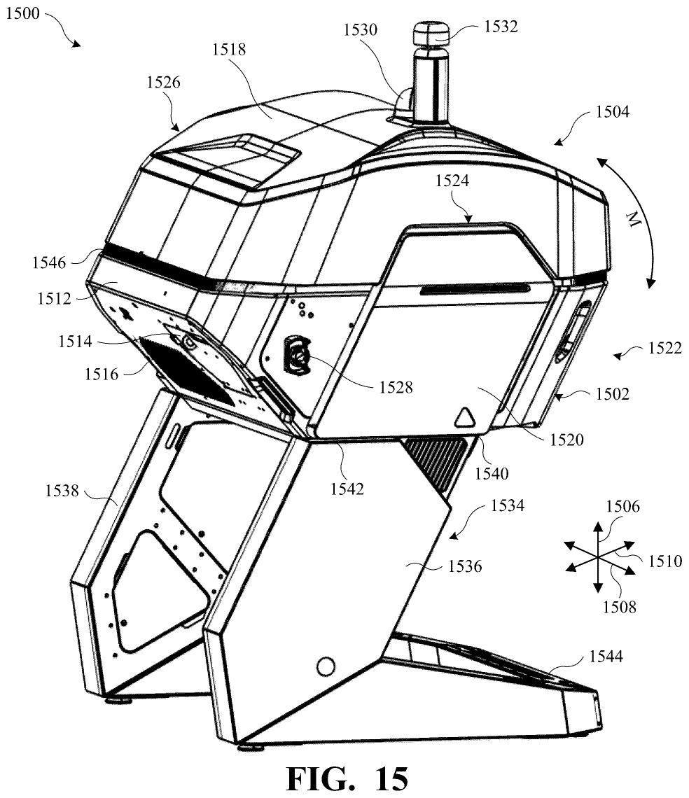

In certain embodiments, the stand 200 is configured to support long term (e.g., permanent) installation at a docking site and includes (one or more) at least one mounting point that facilitates connection of the stand 200 to a mounting pad 300 (or the like), as seen in FIG. 14, which may include one or more anchors 302, one or more conduits, such as a first conduit 306 for power wiring (e.g., AC wires) and/or a second conduit for data communication (e.g., USB and/or ethernet wiring), or a combination thereof.

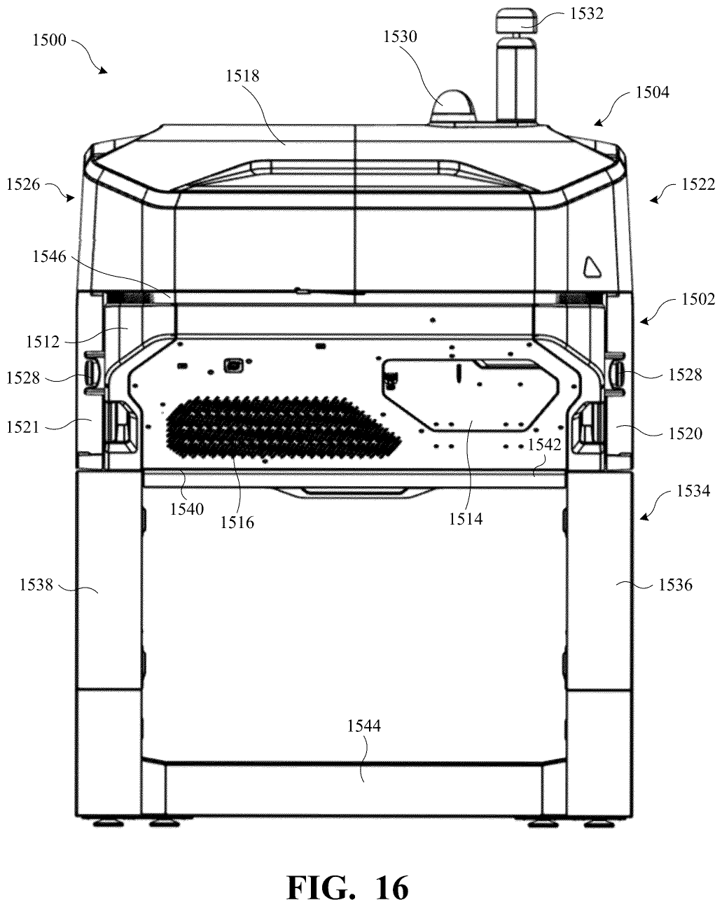

FIG. 15 illustrates a perspective view of another example of a base station 1500. FIG. 16 illustrates a front view of the base station 1500 shown in FIG. 16. The base station 1500 may be similar to the base station 100 of FIGS. 1-23 described above unless otherwise stated. By way of example, the base station 1500 may also include a base 1502 and a roof assembly 1504 movably coupled to the base 1502. As discussed further below, the roof assembly 1504 may be movable between an open position, in which the roof assembly 1504 exposes an interior region of the base 1502, and a closed position, in which the roof assembly 1504 at least partially encloses the interior region of the base 1502. FIG. 15 illustrates the closed position of the roof assembly 1504.

The base station 1500 may be configured to house and/or support a UAV, such as the UAV 10. For example, the base 1502 may be or may include a landing platform (e.g., similar to the landing platform 108 of the base station 100). During operation (e.g., flight) of the UAV 10, the UAV 10 may commence a landing sequence, such as based upon recognition of the landing platform and/or one or more fiducial markings thereon, and land on the landing platform. That is, the UAV 10 may be docked on the landing platform and supported by the landing platform.

When the UAV 10 is docked, the roof assembly 1504 may be configured to move to the closed position shown in FIG. 15 to enclose the landing platform and the UAV 10 supported thereon to protect both the landing platform and the UAV 10 from environmental conditions (e.g., precipitation, debris, sunlight, etc.) When an operator wishes to initiate takeoff of the UAV 10 from the landing platform, the roof assembly 1504 may be actuated to move to the open position, whereby the roof assembly 1504 may be located at least partially below the landing platform with respect to an elevational direction 1506 of movement (e.g., an up-and-down direction). For illustrative purposes, the elevational direction 1506 may be considered movement along or parallel to a Z-axis of the base station 1500, which may be transverse to a lateral direction 1508 of movement (e.g., side-to-side movement along or parallel to an X-axis of the base station 1500) and transverse to a longitudinal direction 1510 of movement (e.g., front-to-back movement, or vice versa, along or parallel to a Y-axis of the base station 1500). As such, when the roof assembly 1504 is in the open position, the landing platform—and thus the UAV 10—are unobstructed by the roof assembly 1504 to facilitate takeoff and landing of the UAV 10.

The base 1502 may include a body 1512 that supports the landing platform. The body 1512 may substantially form an overall shape and housing of the base 1502. As discussed further below, the body 1512 may define a cavity therein, which may contain one or more components of the base station 1500, such as the landing platform, at least a portion of the drive system that actuates the roof assembly 1504, a thermal management system of the base station 1500, electronics (e.g., circuitry, wiring, etc.), or a combination thereof. Additionally, the body 1512 may be movably coupled to the roof assembly 1504 and may help facilitate movement of the roof assembly 1504 between the open position and the closed position.

As mentioned above, the body 1512 may include and/or house one or more components of the base station 1500. By way of example, the body 1512 may store one or more electrical components of the base station 1500, such as a control module, wiring (e.g., power and/or data wiring), one or more sensors (e.g., contact sensors, humidity sensors, temperature sensors, etc.), a charging hub configured to charge a power supply of the UAV 10 when docked, or a combination thereof. Such electrical components may be accessible from outside the base station 1500 via an access module 1514 of the body 1512. The access module 1514 may be an access panel, which may open to allow a user to access or otherwise communicate with the electrical components of the base station 1500. For example, the access module 1514 may be opened to expose a port, whereby the user may connect an external electronic device (e.g., laptop, tablet, mobile phone, etc.) to an electrical system of the base station 1500 via a connector connected to the port to thereby establish a communication path between the electronic device and the electrical system.

Additionally, due to potentially heightened operating temperatures of such an electrical system, the body 1512 may also include venting 1516 to dissipate such heat and ensure that the electrical system of the base station 1500 does not overheat. Similarly, as discussed further below, the venting 1516 may provide a point of egress for drainage (e.g., water) that may enter the body 1512. The venting 1516 may be slits, cutouts, or other openings to promote air flow between the interior region of the body 1512 (e.g., the cavity storing the electronic components therein) and an external environment. In some configurations, the base 1502 may also include one or more heat sinks to further promote heat dissipation from the body 1512. In an example, the electronic components of the base station 1500 may include one or more printed circuit boards (PCBs), which may be coupled to one or more heat sinks located within the body 1512. The one or more heat sinks may be coupled to the body 1512 such that heat generated by the PCBs may be transferred through the one or more heat sinks to the body 1512, at which point the heat may be dissipated into the external environment.

As discussed above, the roof assembly 1504 may be movable coupled to the base 1502. As shown in FIG. 15, the roof assembly 1504 may include a cover 1518 and one or more ears, such a first ear 1520 coupled to the cover 1518 and movably coupled to the body 1512. For example, the first ear 1520 may be coupled to a first side 1522 (e.g., a first lateral side) of the cover 1518, such as within a groove 1524 defined by the cover 1518 and located on the first side 1522 of the cover 1518. The first ear 1520 may extend downward from the cover 1518 with respect to the elevational direction 1506 and coupled to the first side 1522 of the base 1502 (e.g., the first side 1522 of the body 1512) to establish a pivot therebetween.

The roof assembly 1504 may further include a second ear 1521, which may be similar to the first ear 1520 described above, that is coupled to an opposing second side 1526 of the cover 1518. For example, the second ear 1521 may extend downward from the cover 1518 with respect to the elevational direction 1506 and may be coupled to the opposing second side 1526 of the base 1502 (e.g., the opposing second side 1526 of the body 1512) to establish a pivot therebetween. Thus, based on actuation by the drive system of the base station 1500, the first ear 1520 and the second ear 1521 may facilitate movement of the roof assembly 1504 in a direction of movement (M) between the closed position and the open position. That is, the roof assembly 1504 may be rotatable through an angular range of motion that is defined by the first ear 1520 and the second ear 1521. It should also be noted that, in some configurations, the roof assembly 1504 may only include the first ear 1520 or the second ear 1521. For example, the roof assembly 1504 may be rotatable through the angular range of motion defined by the first ear 1520 and the second ear 1521 such that the roof assembly 1504 may be positioned at least partially between the base 1502 and a stand 1534 of the base station 1500 when the roof assembly 1504 is in the open position.

Actuation of the roof assembly 1504 may be done manually and/or remotely. For manual operation, the base station 1500 may include a manual override state in which a user may manually articulate the roof assembly 1504 between the closed position and the open position. For example, the base station 1500 may enter the manual override state for maintenance or during a power outage. However, it is envisioned that the roof assembly 1504 may generally be actuated remotely. For example, when the UAV 10 initiates a takeoff sequence, the takeoff sequence may include communicating with the base station (e.g., via wireless or wired communication) so that the roof assembly 1504 may be actuated in the direction of movement (M) to the open position. Similarly, when the UAV 10 lands on the landing platform, the base station 1500 may detect the UAV 10 (or the UAV 10 may communicate with the base station 1500 that it has landed), at which point the roof assembly 1504 may be actuated in the direction of movement (M) to the closed position.

Moreover, a user may actuate the roof assembly 1504 based upon user input, such as via an external electronic device in communication with the base station 1500 and/or a user interface disposed on the base station 1500, such as the user interface 1528. For example, the user interface 1528 may be disposed along an exterior surface of the body 1512, such as along the first side 1522 and/or the opposing second side 1526 of the body 1512. The user may interact with the user interface 1528 (e.g., push, contact, slide, switch, etc.) to activate movement of the roof assembly 1504.

Similarly, in certain circumstances the user may wish to manually stop actuation of the roof assembly 1504. For example, the user may wish to initiate an emergency stop of the roof assembly 1504 midway through actuation of the roof assembly 1504 between the open position and the closed position. In such a case, the user may stop movement of the roof assembly 1504 between the closed position and the open position by interacting with the user interface 1528.

As discussed above, the base station 1500 may include one or more electrical components that are disposed within the cavity of the body 1512. The base station 1500 may include one or more electrical components, such as one or more sensors, along an exterior of the body 1512 and/or the cover 1518. For example, as shown in FIG. 15, the roof assembly 1504 may include a rain sensor 1530 (e.g., to detect rain or a severity thereof) and a wind sensor 1532 (e.g., to detect wind or a severity thereof) coupled to an exterior surface of the cover 1518, such as along a top exterior surface of the cover 1518 so that the rain sensor 1530 and the wind sensor 1532 are located above substantially all of the base station 1500 in the elevational direction 1506. As such, the rain sensor 1530 and the wind sensor 1532 may detect rain and wind, respectively, substantially unencumbered by the base station 1500. It should be noted that any type of sensor may be disposed along the exterior surface of the base station 1500. For example, the base station 1500 may include one or more contact sensors, one or more pressure sensors, one or more temperature sensors, other sensors, or a combination thereof disposed along the exterior surface of the base station 1500.

Turning back to FIG. 15, the first ear 1520 and the second ear 1521 may be coupled to the body 1512 such that the roof assembly 1504 is movable (e.g., in the direction of movement (M)) between the closed position, in which the cover 1518 is configured to enclose the landing platform and the UAV 10 supported thereon, and an open position, in which the cover is located at least partially below the landing platform (e.g., below the body 1512) with respect to the elevational direction 1506 such that the landing platform is unobstructed by the cover 1518 to facilitate takeoff and landing of the UAV 10. To facilitate such articulation of the roof assembly 1504, the base 1502 may be coupled to the stand 1534.

The stand 1534 may include one or more legs, such as the first leg 1536 and the second leg 1538, which may support the base 1502 and thus also support the roof assembly 1504. For example, a lower surface 1540 of the body 1512 may be supported along an upper surface 1542 of the first leg 1536 and/or the second leg 1538. The first leg 1536 and/or the second leg 1538 may substantially define a clearance height for articulation of the roof assembly 1504. That is, the first leg 1536 and/or the second leg 1538 may extend upward in the elevational direction 1506 such that the base 1502 is raised above the ground to thereby provide an area in which the roof assembly 1504 is free to articulate at least partially beneath the body 1512 (e.g., in the open position). The first leg 1536 and the second leg 1538 may also be coupled to one another and/or further structurally reinforced by a frame 1544. As shown in FIG. 15 the frame 1544 may extend between the first leg 1536 and the second leg 1538 (e.g., may extend between the first side 1522 and the opposing second side 1526 of the base station 1500) to improve stability of the stand 1534.

To further improve operation of the base station 1500, the base station 1500 may include indicator lighting 1546 extending at least partially around a perimeter (e.g., a periphery) of the base 1502. The indicator lighting 1546 may remain unobstructed by the roof assembly 1504 when the roof assembly 1504 is in the open position and when the roof assembly 1504 is in the closed position. That is, the indicator lighting 1546 may remain unobstructed by the roof assembly 1504 before, during, and after actuation of the roof assembly 1504. As such, the indicator lighting 1546 may provide a visual indication of activity of the base station 1500. In an example, the indicator lighting 1546 may illuminate during opening and/or closing of the roof assembly 1504.

Similarly, the indicator lighting 1546 may illuminate when the UAV 10 is docked within the base station 1500, when the base station 1500 is receiving power from an external power source, when the base station 1500 is malfunctioning, or a combination thereof. Illumination herein by the indicator lighting 1546 may be considered any lighting provided by the indicator lighting 1546 in any color, pattern (e.g., rate of pulsing), intensity, or a combination thereof. The indicator lighting 1546 may also be any lighting component that may facilitate such illumination, such as, for example, an LED panel (e.g., a backlit and/or edge-lit LED panel), fluorescent lighting, LED strips, or a combination thereof. However, the indicator lighting 1546 is not limited to any particular lighting component.

As shown in FIG. 15, the base station 1500 may be configured to substantially prevent moisture and/or debris from entering the confines of the base 1502 when the roof assembly 1504 is in the closed position. For example, the roof assembly 1504 may be shaped such that water (e.g., rain) which lands on the cover 1518 may be directed away from the confines of the body 1512 to prevent the water from penetrating the base station 1500 and contacting one or more of the landing platform (including the UAV 10, which may be supported thereon), the electronics located within the base 1502, or the thermal management system located within the base 1502. In an example, a portion of the base 1502, such as the landing platform and/or indicator lighting 1546, may be at least partially nested within the roof assembly 1504 (e.g., within the cover 1518) so that the water may be directed over the surface of the cover 1518 and away from the base 1502. As such, the cover 1518 may dimensionally span a greater distance in the lateral direction 1508 and/or the longitudinal direction 1510 compared to the base 1502 to cover the base 1502 and protect the base 1502 from the water.

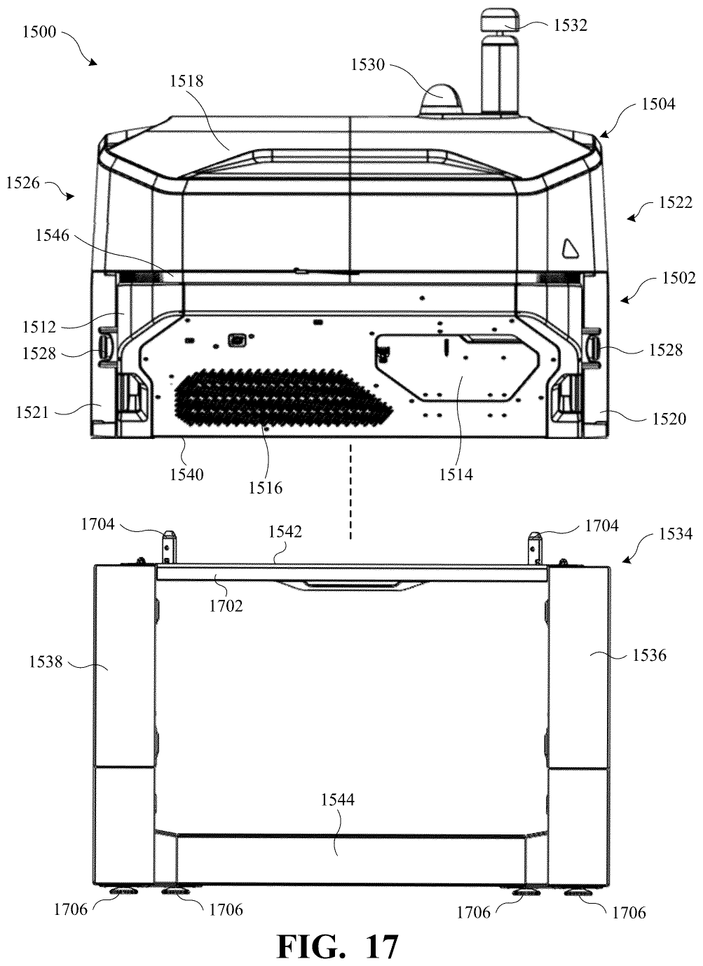

FIG. 17 illustrates a partially exploded view of the base station 1500. As discussed above, the base station 1500 (e.g., the base 1502 and/or the roof assembly 1504) may be supported by the stand 1534. For example, the stand 1534 may be coupled to the base 1502 and configured to support the base 1502 thereon.

The stand 1534 may include the first leg 1536 located on the first side 1522 of the base station 1500, the second leg 1538 located on the opposing second side 1526 of the base station 1500, and the frame 1544, which may extend between the first leg 1536 and the second leg 1538. For example, the frame 1544 may be a crossbar or other stabilizing structure that extends between the first leg 1536 and the second leg 1538 and is coupled to both the first leg 1536 and the second leg 1538. As such, the frame 1544 may substantially prevent unwanted movement between the first leg 1536 and the second leg 1538. Coupling of the frame 1544 to the first leg 1536 and the second leg 1538 is not particularly limited and can be done using any mechanical engagement (e.g., fasteners, locking mechanisms, etc.), adhesives, bonding (e.g., welding), or other techniques.

The stand 1534 may further include a spreader plate 1702 supported by at least one of the first leg 1536 and the second leg 1538. The spreader plate 1702 may be configured to support the base 1502 of the base station 1500. For example, as shown in FIG. 17, the spreader plate 1702 may define the upper surface 1542 of the stand 1534 and the lower surface 1540 of the base 1502 may abut the upper surface 1542 of the spreader plate 1702 so that the base 1502 is supported by the stand 1534. As shown in FIG. 17, the frame 1544 may be spaced apart from the spreader plate 1702, such as in the elevational direction 1506 of the base station 1500. Moreover, the frame 1544 and the spreader plate 1702 may extend along planes that are substantially parallel to one another or skewed to one another. As such, the first leg 1536 and/or the second leg 1538 may extend substantially perpendicular to the frame 1544 and the spreader plate 1702. However, such orientation is not particularly limited to being substantially perpendicular.

To facilitate proper alignment and/or engagement between the stand 1534 and the base 1502, the spreader plate 1702 may include one or more guide pins, such as the guide pins 1704 that are received by the base 1502 (e.g., the body 1512) to align the base 1502 with the stand 1534. For example, the spreader plate 1702 may include a pair of the guide pins 1704 that project away from the spreader plate 1702 (e.g., away from the upper surface 1542 of the spreader plate 1702), whereby the pair of the guide pins 1704 may be receivable by the base station 1500 (e.g., by the base 1502 of the base station 1500) to align the base station 1500 (e.g., the base 1502 of the base station 1500) with the stand 1534. The base 1502 may then be secured to the spreader plate 1702 when the base 1502 is aligned with the stand 1534. For example, as discussed further below, the spreader plate 1702 and the base 1502 may be coupled to one another via one or more fasteners. As such, the guide pins 1704 may ensure that the base 1502 and the spreader plate 1702 are properly aligned such that the fasteners may properly connect the base 1502 to the spreader plate 1702.

To further improve stability of the base station 1500, the stand 1534 may include one or more adjustable feet, such as the adjustable feet 1706. As discussed further below, the adjustable feet 1706 may be configured to adjust a height of the stand 1534—and thus also a height of the base station 1500. The adjustable feet 1706 may further provide means for leveling the base station 1500 on an uneven surface or platform. For example, each of the adjustable feet 1706 may be independently adjusted (e.g., a height thereof) to ensure that the base station 1500 remains substantially level.

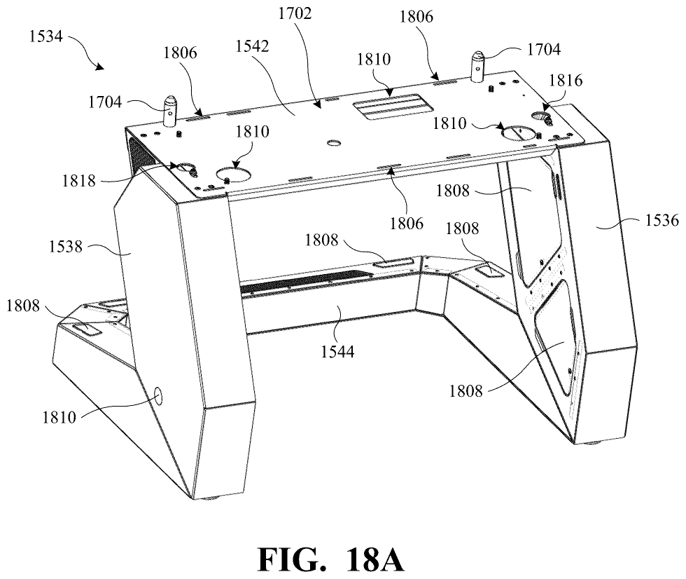

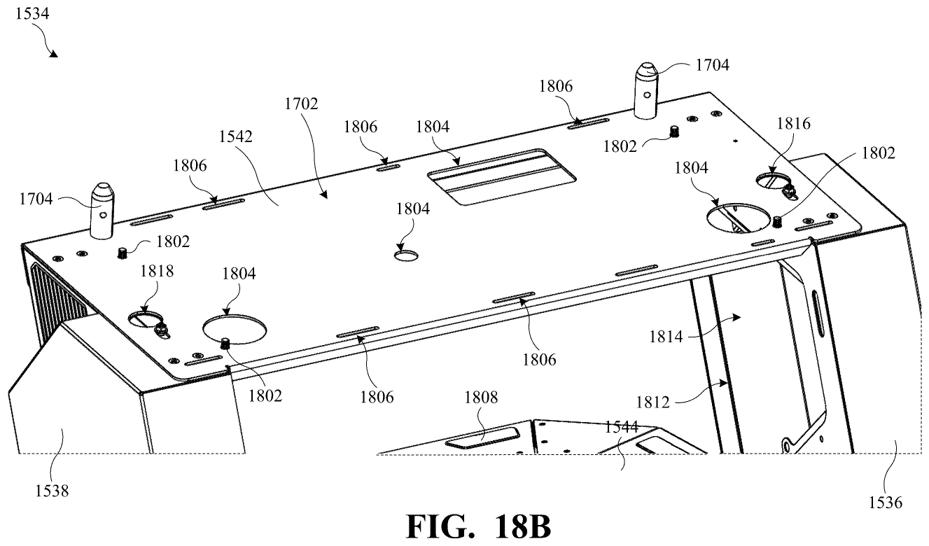

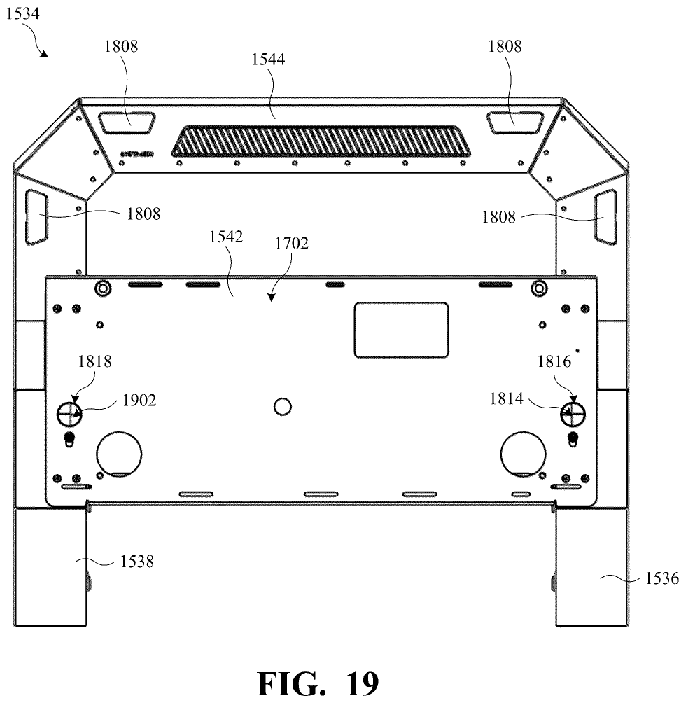

FIG. 18A illustrates a perspective view of the stand 1534 of the base station 1500. FIG. 18B is a close-up perspective view of the stand 1534 shown in FIG. 18A. As discussed above, the stand 1534 may be configured to support the base 1502 of the base station 1500 and may be coupled to the base 1502.

By way of example, the base 1502 may be positioned on the upper surface 1542 of the stand 1534 that is defined by the spreader plate 1702, which may be coupled to and supported by the first leg 1536 and the second leg 1538. The base 1502 may receive the guide pins 1704 projecting (e.g., extending) from the upper surface 1542 of the spreader plate 1702 to align the base 1502 with the stand 1534. As such, one or more fasteners, such as the fasteners 1802, may be properly aligned to couple the base 1502 to the stand 1534 (e.g., to the spreader plate 1702) to support the base 1502 thereon. For example, the fasteners 1802 may extend from the spreader plate 1702 and be received by mounting holes defined by the base 1502 (e.g., defined by the body 1512 of the base 1502). The fasteners 1802 are not particularly limited to any specific type of fastener. For example, the fasteners 1802 may be bolts (e.g., bolts that are secured to the base 1502 and/or the stand 1534 via threaded nuts), screws, mechanical interlocks, clips, other types or fasteners, or a combination thereof.

Proper alignment between the base 1502 and the stand 1534 may also help align one or more additional features of the spreader plate 1702 with the base 1502. For example, the spreader plate 1702 may define one or more cutouts 1804, which may be aligned with portions of the base 1502, such as features along the lower surface 1540 of the base 1502, to permit access to such features. By way of example, the one or more cutouts 1804 may be aligned with electrical connections of the base 1502, mounting features of the base 1502, openings defined by the base 1502, other features of the base 1502, or a combination thereof. Similarly, the spreader plate 1702 may further define one or more drain slots, such as the drain slots 1806, which may be aligned with drain slots defined by the base 1502 (e.g., defined by the body 1512 of the base 1502). As such, if moisture (e.g., water) enters an interior cavity defined by the body 1512, the moisture may egress through the drain slots of the base 1502 and thus also through the drain slots 1806 of the spreader plate 1702. Thus, the spreader plate 1702 need not obstruct proper drainage of moisture out of the base 1502.

When the base 1502 is coupled to the stand 1534, the stand 1534 may be configured to support one or more of power transmission and data transmission to the base station 1500 (e.g., to the base 1502) via the stand 1534. By way of example, wiring may be routed through all or a portion of the stand 1534 such that the wiring may be connected to the base 1502 to provide power transmission and/or data transmission to the base station 1500. For example, the first leg 1536 and/or the second leg 1538 may define a cavity therein, whereby the wiring may be routed through such cavities to reach the base 1502.

As shown in FIG. 18A, the first leg 1536 and/or the second leg 1538 may include one or more access panels, such as the access panels 1808, one or more punchouts, such as the punchouts 1810, or both. The access panels 1808 and/or the punchouts 1810 may enclose one or more respective openings of the first leg 1536 and/or the second leg 1538, such as the opening 1812, that permit access to the cavities defined by the first leg 1536 and/or the second leg 1538, such as a first cavity 1814 defined by the first leg 1536.

That is, the first leg 1536 may define the first cavity 1814 therein that may be accessible through one or more openings (e.g., the opening 1812) of the first leg 1536 and the second leg 1538 may define a second cavity therein that may be accessible through one or more openings of the second leg 1538. As such, the first cavity 1814 may permit routing of the wiring through the first leg 1536 to connect the wiring to the base station 1500 and the second cavity may permit routing of the wiring or the additional wiring through the second leg 1538 to connect the wiring or the additional wiring to the base station 1500. For example, the wiring routed through the first leg 1536 may be configured to transmit power to the base station 1500 via the stand 1534 and the additional wiring routed through the second leg 1538 may be configured to transmit data to the base station 1500 via the stand 1534.

As such, removal of the access panels 1808 and/or the punchouts 1810 may allow the wiring to be routed through the first leg 1536 and/or the second leg 1538 to reach the base 1502. By way of example, the wiring may be routed into the cavity of the second leg 1538 through one of the punchouts 1810 located on the second leg 1538, at which point the wiring may be accessed through one or more of the access panels 1808 located along the second leg 1538 to manipulate the wiring and route the wiring through the second leg 1538 towards the body 1512.

A similar structure may also exist for the frame 1544. For example, the frame 1544 may define a frame cavity therein, which may be accessible through one or more of the access panels 1808 and/or one or more of the punchouts 1810. As such, the wiring may also be routed through all or a portion of the frame 1544 to connect the wiring to the base 1502. Furthermore, to ensure that the wiring is properly routed to the base 1502, the spreader plate 1702 may further define one or more apertures, such as a first aperture 1816 and a second aperture 1818. As such, the wiring may be routed through the spreader plate 1702 (e.g., through the first aperture 1816 and/or the second aperture 1818) and into the base 1502 unobstructed by the spreader plate 1702.

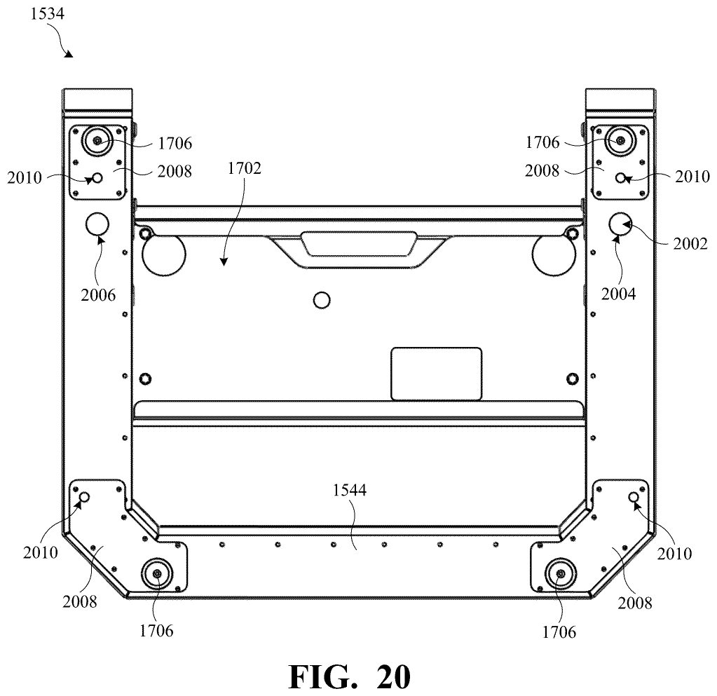

FIG. 19 is a top view of the stand 1534 and FIG. 20 is a bottom view of the stand 1534 to better illustrate possible avenues to route the wiring through the stand 1534 to connect the wiring to the base station 1500 (e.g., to the base 1502). As discussed above and shown in FIG. 19, the spreader plate 1702 may define one or more apertures that permit access to one or more of the first cavity 1814 defined by the first leg 1536 and the second cavity 1902 of the second leg 1538, which may be similar to the first cavity 1814 unless otherwise stated. In particular, the spreader plate 1702 may define the first aperture 1816 that permits access to the first cavity 1814 of the first leg 1536. The spreader plate 1702 may also define the second aperture 1818 that permits access to the second cavity 1902 of the second leg 1538. As such, wiring that is routed through the first leg 1536 (e.g., the first cavity 1814) may be routed through the first aperture 1816 and into the base 1502 for connection. Similarly, wiring that is routed through the second leg 1538 (e.g., the second cavity 1902) may be routed through the second aperture 1818 and into the base 1502 for connection.

To further illustrate connection of the base station 1500 for power and/or data transmission, FIG. 20 will now be discussed in further detail. As discussed above, the frame 1544 may extend between the first leg 1536 and the second leg 1538, and may define cavity (e.g., a frame cavity 2002) therein. The frame cavity 2002 may be accessible through the first cavity 1814 of the first leg 1536 and/or the second cavity 1902 of the second leg 1538 to permit routing the wiring through the frame 1544 and into the first cavity 1814 and/or the second cavity 1902. The frame cavity 2002 may also be accessible through one or more apertures defined by the frame 1544, such as a first aperture 2004 and a second aperture 2006, which may be located near the first leg 1536 and the second leg 1538, respectively. As such, the wiring may be routable through one or more of the first cavity 1814, the second cavity 1902, and the frame cavity 2002 to transmit one or more of power and data to the base station 1500 (e.g., the base 1502) via the stand 1534.

By way of example, the wiring may be routable through the stand 1534 to connect the wiring to the base 1502 by routing the wiring into the frame cavity 2002 (e.g., through the first aperture 2004 and/or the second aperture 2006 of the frame 1544), through the frame cavity 2002, into the first cavity 1814 of the first leg 1536, and through the first cavity 1814 such that the wiring exits the first cavity 1814 through the one or more apertures of the spreader plate 1702, such as the first aperture 1816 of the spreader plate 1702. Similarly, the wiring may be routable through the stand 1534 to connect the wiring to the base 1502 by routing the wiring into the frame cavity 2002 (e.g., through the first aperture 2004 and/or the second aperture 2006 of the frame 1544), through the frame cavity 2002, into the second cavity 1902 of the second leg 1538, and through the second cavity 1902 such that the wiring exits the second cavity 1902 through the one or more apertures of the spreader plate 1702, such as the second aperture 1818 of the spreader plate 1702.

In addition to facilitating wiring of the base station 1500, the frame 1544 may also stabilize and/or secure the base station 1500. For example, as shown in FIGS. 19 and 20, the frame 1544 may extend outboard (e.g., away from) the base 1502 in the longitudinal direction 1510 and/or the lateral direction 1508. As a result, the frame 1544 and thus the stand 1534 may include counterweighting measures (e.g., weights, mounting, etc.) or otherwise provide counterweighting such that the stand 1534 may remain stationary when the roof assembly 1504 of the base station 1500 moves between the close position and the open position with respect to the base station 1500. That is, the frame 1544 may provide an anti-tipping measure to ensure that the base station 1500 remains upright during operation even if the stand 1534 is not anchored to the ground or another surface.

Though the stand 1534 may facilitate freestanding of the base station 1500, the base station 1500 may also be anchored to the ground or another surface. For example, as shown in FIG. 20, the adjustable feet 1706 may be secured to the frame 1544 via plates 2008, which may be braces, brackets, stiffeners, or other mounting plates. While the adjustable feet 1706 are supported by the ground or another surface, anchors may extend through anchor holes 2010 defined by one or more of the plates 2008 and into the ground or another surface to anchor the stand 1534—and thus the base station 1500—to the ground or another surface. As such, the stand 1534 may provide various means to support and/or secure the base station 1500 during operation.

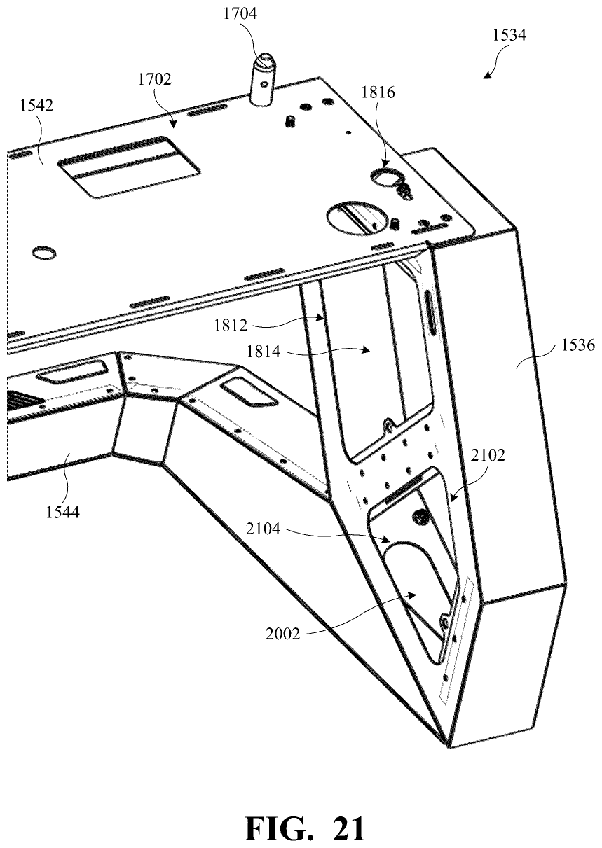

FIG. 21 illustrates another close-up perspective view of the stand 1534 to further illustrate an interior of the stand 1534. As discussed above, the first leg 1536 may define the first cavity 1814 therein and the second leg 1538 may define the second cavity 1902 therein. For example, as shown in FIG. 21, the first cavity 1814 of the first leg 1536 may be accessible via one or more openings, such as the opening 1812 and the additional opening 2102, whereby the opening 1812 and/or the additional opening 2102 may be enclosed by one or more access panels, such as the access panels 1808 shown in FIG. 18A. As such, wiring may be routed through the first cavity 1814 of the first leg 1536 and through the first aperture 1816 of the spreader plate 1702 to reach the base 1502 for connection. It should also be noted that first cavity 1814 may also provide storage (e.g., a storage compartment) to store additional items, such as tools and/or accessories for the base station 1500 or the UAV 10 supported thereon. It should also be noted that while only the first leg 1536 is illustrated in FIG. 21, a similar configuration may be present for the second leg 1538. That is, the second cavity 1902 of the second leg 1538 may also be accessible through one or more openings defined by the second leg 1538, which may also be covered by one or more of the access panels 1808.

The first cavity 1814 of the first leg 1536 and/or the second cavity 1902 of the second leg 1538 may be in communication with the frame cavity 2002 of the frame 1544. For example, the frame 1544 may define one or more openings, such as a first opening 2104 located near the first leg 1536 and/or an opposing second opening located near the second leg 1538. The first leg 1536 and the second leg 1538 may be connected to the frame 1544 such that the first opening 2104 and the second opening of the frame 1544 are accessible through the first leg 1536 and the second leg 1538, respectively. That is, the first opening 2104 of the frame 1544 may be aligned with the first leg 1536 such that the frame cavity 2002 may be accessible through the first opening 2104 of the frame 1544 from within the first cavity 1814 of the first leg 1536. Similarly, the second opening (e.g., the second opening opposing the first opening 2104 near an opposing side of the frame 1544) may be aligned with the second leg 1538 such that the frame cavity 2002 may be accessible through the second opening of the frame 1544 from within the second cavity 1902 of the second leg 1538. As such, wiring may be routed directly through the frame 1544 into the first cavity 1814 of the first leg 1536 and/or the second cavity 1902 of the second leg 1538.

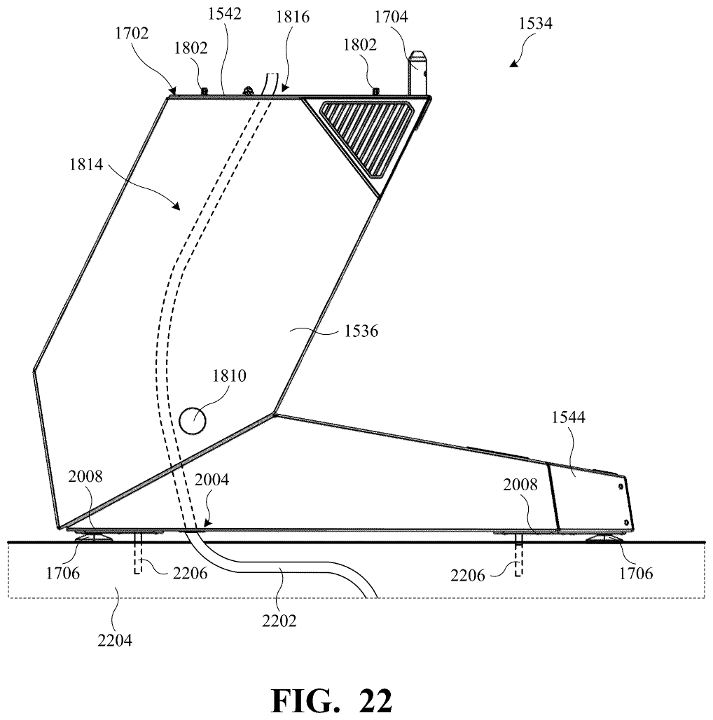

FIG. 22 further illustrates a side view of the stand 1534 to show routing of wiring, such as the wiring 2202, through the first leg 1536. As shown in FIG. 22, the stand 1534—and thus the base station 1500—may be mounted to a platform 2204 (e.g., the ground or another surface), via anchors 2206 that extend through the plates 2008 coupled to the frame 1544 and into the platform 2204, thereby securing the base station 1500 to the platform 2204. The wiring 2202 may extend from beneath the platform 2204 or another location external to the base station 1500. As such, the wiring 2202 may be routed into the frame cavity 2002 through the first aperture 2004 of the frame 1544, through the frame cavity 2002 and into the first cavity 1814 of the first leg 1536 via the first opening 2104 of the frame 1544, and finally through the first aperture 1816 of the spreader plate 1702 to connect the wiring 2202 to the base 1502. Alternatively, the wiring 2202 may be routed directly into the first cavity 1814 of the first leg 1536 through the opening covered by one of the punchouts 1810 located on the first leg 1536.

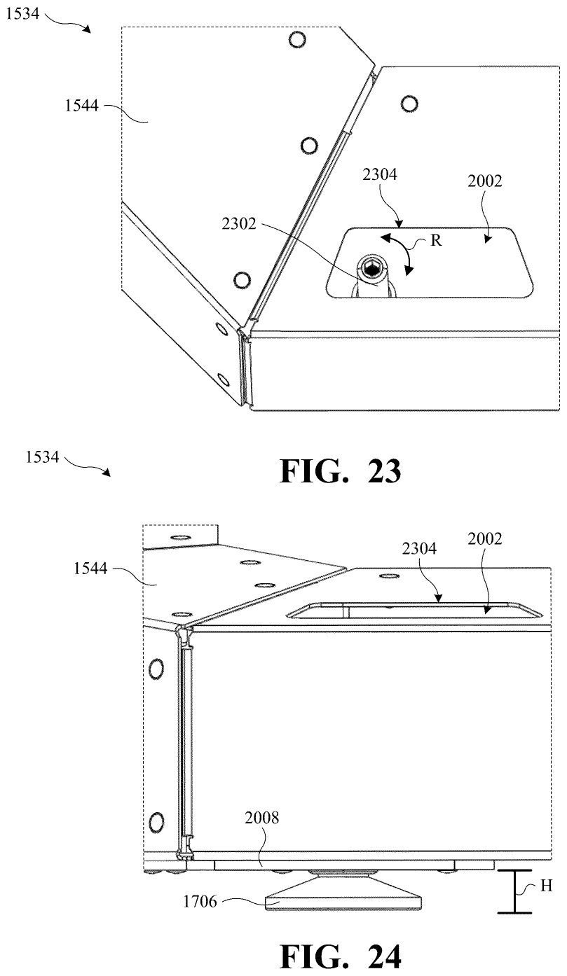

FIG. 23 illustrates a close-up view of one of the adjustable feet 1706 of the stand 1534. FIG. 24 illustrates a side view of the adjustable foot shown in FIG. 23. It should be noted that the description of the adjustable foot shown in FIGS. 23 and 24 may also be applicable to any of the adjustable feet 1706 of the stand 1534 described herein.

The adjustable feet 1706 may be configured to adjust a height (H) of the stand 1534 with respect to the elevational direction 1506 of the base station 1500 to thereby adjust the overall height of the base station 1500 with respect to the ground or another surface (e.g., a platform). To facilitate such adjustment, each of the adjustable feet 1706 may include a spindle 2302, which may be rotated, such as in the direction (R), to increase and/or decrease the height (H) of the stand 1534. By way of example, the spindle 2302 of one of the adjustable feet 1706 shown in FIG. 23 may be located in the frame cavity 2002 of the frame 1544. As such, the spindle 2302 may be accessible through an opening defined by the frame 1544, such as an opening 2304, which may be covered by one of the access panels 1808 described above. As such, the spindle 2302 of all or a portion of the adjustable feet 1706 may be contained within the frame 1544, thereby protecting such mechanisms from environmental concerns (e.g., moisture and/or debris).

Persons skilled in the art will understand that the various embodiments of the disclosure described herein and shown in the accompanying figures constitute non-limiting examples, and that additional components and features may be added to any of the embodiments discussed herein above without departing from the scope of the present disclosure. Additionally, persons skilled in the art will understand that the elements and features shown or described in connection with one embodiment may be combined with those of another embodiment without departing from the scope of the present disclosure and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the disclosure, as are alternative embodiments that may result from combining, integrating, and/or omitting features from any of the disclosed embodiments.

Use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (i.e., an angle that lies within the range of (approximately) 135° to (approximately) 225°) and the term “generally orthogonal” should be understood as referring to configurations in with the pertinent components are oriented so as to define an angle therebetween that is equal to 90°±25% (i.e., an angle that lies within the range of (approximately) 67.5° to (approximately) 112.5°). The term “generally parallel” should thus be understood as referring to encompass configurations in which the pertinent components are arranged in parallel relation, and the term “generally orthogonal” should thus be understood as referring to encompass configurations in which the pertinent components are arranged in orthogonal relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

Each and every claim is incorporated as further disclosure into the specification and represents embodiments of the present disclosure. Also, the phrases “at least one of A, B, and C” and “A and/or B and/or C” should each be interpreted to include only A, only B, only C, or any combination of A, B, and C.

What is claimed is:

1. A base station for an unmanned aerial vehicle (UAV), comprising:
a base that includes:
a body; and
a landing platform supported by the body;
a roof assembly movably coupled to the base and movable between a closed position and an open position; and
a stand removably coupled to the base and that includes:
a first leg;
a second leg;
a frame extending between the first leg and the second leg; and
a spreader plate supported by at least one of the first leg and the second leg,
wherein the spreader plate is configured to support the base,
wherein the stand is configured to support one or more of power transmission and data transmission to the base station via the stand.

2. The base station of claim 1, wherein the spreader plate defines an upper surface of the stand, and wherein a lower surface of the base abuts the upper surface of the spreader plate so that the base is supported by the stand.

3. The base station of claim 1, wherein the first leg defines a first cavity therein that is accessible through one or more openings defined by the first leg, and the second leg defines a second cavity therein that is accessible through one or more openings defined by the second leg.

4. The base station of claim 3, wherein the first cavity permits routing of wiring through the first leg to connect the wiring to the base station, and wherein the second cavity permits routing of additional wiring through the second leg to connect the additional wiring to the base station.

5. The base station of claim 4, wherein the wiring is configured to transmit power to the base station via the stand and the additional wiring is configured to transmit data to the base station via the stand.

6. The base station of claim 1, wherein the spreader plate includes one or more guide pins that are received by the body of the base to align the base with the stand, and wherein the base is secured to the spreader plate when the base is aligned with the stand.

7. The base station of claim 1, wherein the frame is spaced apart from the spreader plate in an elevational direction of the base station, and wherein the frame and the spreader plate extend along planes that are substantially parallel to one another.

8. The base station of claim 1, wherein the roof assembly is configured for positioning at least partially between the base and the stand when the roof assembly is in the open position.

9. A base station for an unmanned aerial vehicle (UAV), comprising:
a base configured to support the UAV; and
a stand coupled to the base and configured to support the base, wherein the stand includes:
a first leg defining a first cavity therein;
a second leg defining a second cavity therein;
a frame extending between the first leg and the second leg, wherein the frame defines a frame cavity therein that is accessible via one or more of the first cavity and the second cavity; and
a spreader plate coupled to and supported by the first leg and the second leg,
wherein the spreader plate is coupled to the base to support the base thereon, and wherein the spreader plate defines one or more apertures that permit access to one or more of the first cavity of the first leg and the second cavity of the second leg.

10. The base station of claim 9, wherein wiring is routable through the stand to connect the wiring to the base by routing the wiring into the frame cavity, through the frame cavity, into the first cavity, and through the first cavity such that the wiring exits the first cavity through the one or more apertures of the spreader plate.

11. The base station of claim 9, wherein wiring is routable through the stand to connect the wiring to the base by routing the wiring into the frame cavity, through the frame cavity, into the second cavity, and through the second cavity such that the wiring exits the second cavity through the one or more apertures of the spreader plate.

12. The base station of claim 9, wherein the spreader plate defines:
a first aperture that permits access to the first cavity of the first leg; and
a second aperture that permits access to the second cavity of the second leg.

13. The base station of claim 9, wherein the first cavity is accessible via one or more openings defined by the first leg, and wherein the one or more openings are enclosed by one or more access panels.

14. The base station of claim 13, wherein the second cavity is accessible via one or more additional openings defined by the second leg, and wherein the one or more additional openings are enclosed by one or more additional access panels.

15. The base station of claim 9, wherein the frame defines a first opening and a second opening that permit access to the frame cavity, the first opening is aligned with the first leg such that the frame cavity is accessible through the first opening of the frame from within the first cavity of the first leg, and the second opening is aligned with the second leg such that the frame cavity is accessible through the second opening of the frame from within the second cavity of the second leg.

16. A stand for a base station for an unmanned aerial vehicle (UAV), comprising:
a first leg defining a first cavity therein;
a second leg defining a second cavity therein;
a spreader plate coupled to the first leg and the second leg, wherein the spreader plate is configured to support the base station; and
a frame extending between the first leg and the second leg, wherein the frame defines a frame cavity therein,
wherein wiring is routable through one or more of the first cavity, the second cavity, and the frame cavity to transmit one or more of power and data to the base station via the stand, and wherein the stand includes counterweighting such that the stand is configured to remain stationary when a roof assembly of the base station moves between a closed position and an open position with respect to the base station.

17. The stand of claim 16, wherein the first leg and the second leg extend substantially perpendicular to the frame and the spreader plate.

18. The stand of claim 16, wherein the first leg extends along a first axis and the frame extends along a second axis, and an angle between the first axis and the second axis is within a range of about 30 degrees to about 75 degrees.

19. The stand of claim 16, wherein the spreader plate defines an upper surface of the stand, and wherein the spreader plate includes a pair of guide pins that project away from the spreader plate and are receivable by the base station to align the base station with the stand.

20. The stand of claim 16, further comprising:
one or more adjustable feet configured to adjust a height of the stand with respect to an elevational direction, wherein the one or more adjustable feet each include a spindle that is located in the frame cavity and is rotatable to adjust the height of the stand.
